(19) United States
(12) Patent Application Publication
(10) Pub. No.: US 2016/0351865 A1
(43) Pub. Date: Dec. 1, 2016

(54) FOLDED LAMINATE BATTERY CELL

(71) Applicant: GM Global Technology Operations LLC, Detroit, MI (US)

(72) Inventors: Anthony Ottomano, Warren, MI (US); Qian Lin, Troy, MI (US); Yan Wu, Troy, MI (US)

(21) Appl. No.: 14/722,893

(22) Filed: May 27, 2015

(51) Int. Cl. H01M 2/06; H01M 2/02

(52) U.S. Cl. CPC H01M 2/06; H01M 2/0287; H01M 2/0275; H01M 2/0285; H01M 2/0277

(57) ABSTRACT

Methods and battery cells formed thereby are provided that minimize issues with an exposed metallic layer at the peripheral edge of a flexible laminate forming a battery cell pouch. Sealing the periphery of the pouch is optimized projecting terminals of the electrochemical cell through perforations in the flexible laminate at a folded edge thereof. The folded edge does not present an exposed metallic layer and does not require a sealing material or use of sealing operation complicated by the terminals.

### FIELD OF THE INVENTION

The present technology relates to battery cells, including laminated pouch battery cells having improved electrical isolation and methods to fabricate such battery cells.

### BACKGROUND OF THE INVENTION

This section provides background information related to the present disclosure which is not necessarily prior art.

A battery cell can provide a clean, efficient, and environmentally responsible electrical power source for various applications, including powering a hybrid or purely electric vehicle. One type of battery cell is a lithium-ion battery. The lithium-ion battery can be rechargeable and can be formed into a wide variety of shapes and sizes to efficiently fit within the available space of the electric vehicle. For example, the battery cell may be prismatic in shape to facilitate a stacking of the battery cells. A plurality of individual battery cells can be provided in a battery assembly to provide an amount of electrical energy sufficient to operate the electric vehicle.

A prismatic battery cell can have a pouch shape formed by a pair of laminate sheets, including various plastic and metallic layers, that are fused or heat sealed around a periphery of an electrochemical cell to seal the battery cell components therein. For example, the pouch can be formed by one or more metal foils sandwiched by thermoplastic layers. Assembly of the battery cell can include providing one of the laminate sheets with a depression or cavity. The electrochemical cell components are disposed within or on the depression or cavity of the plastic coated metal layer. The other laminate sheet is then placed on top of the battery cell components and the peripheries of the laminate sheets are fused together, for example, by heat sealing around the edges to form a sealed pouch.

Effective use of the battery cell can depend on electrically insulating various portions of the battery cell, maintaining desired electrically conductive pathways, and optimizing integrity of the battery cell components. Various materials and fluids can conduct electricity during charging and discharging cycles of the battery cell. With respect to the pouch material, one or more metallic layers in the laminate can provide a hermetic seal barrier for the electrochemical cell. Maintaining electrical neutrality of the metallic layer from the surrounding components can be important in certain applications, such as vehicle battery packs, for improved performance and longevity of the battery cell. Proper insulation of the metallic layers can improve electrical isolation.

There is a continuing need to optimize battery assembly and component integrity while maintaining electrically insulated portions of the battery cell and maintaining desired electrically conductive pathways of the battery cell.

### SUMMARY OF THE INVENTION

The present technology includes articles of manufacture, systems, and processes that relate to battery cells having a pouch formed of a flexible laminate with one or more terminals projecting therefrom.

Battery cells are provided that include an electrochemical cell having a terminal and a flexible laminate configured as a pouch. The pouch defines an interior and an exterior, where the electrochemical cell is disposed in the interior. The pouch includes a folded edge of the flexible laminate having a perforation therein, where the terminal is disposed through the perforation with a portion of the terminal exposed to the exterior of the pouch. The flexible laminate can include a barrier layer, where the barrier layer can be a metallic layer that can be electrically conductive.

Methods of making a battery cell are provided that include perforating a flexible laminate to form a perforation therein. A terminal of an electrochemical cell is disposed through the perforation. The flexible laminate is formed into a pouch, where the pouch defines an interior and an exterior. The electrochemical cell is disposed in the interior and the terminal is disposed through the perforation. A portion of the terminal is exposed to the exterior of the pouch. The flexible laminate can be folded to form a folded edge where the perforation is located on the folded edge.

Further areas of applicability will become apparent from the description provided herein. The description and specific examples in this summary are intended for purposes of illustration only and are not intended to limit the scope of the present disclosure.

### BRIEF DESCRIPTION OF THE DRAWINGS

The drawings described herein are for illustrative purposes only of selected embodiments and not all possible implementations, and are not intended to limit the scope of the present disclosure.

FIG. 1 is a cross-sectional view of an embodiment of a flexible laminate used to form a battery cell pouch.

FIG. 2 is a perspective view of a sheet of the flexible laminate of FIG. 1 having a fold line formed therein, where two perforations in the flexible laminate are located at the fold line.

FIG. 3 is an enlarged fragmentary front elevational view of an electrochemical battery cell showing two terminals of the electrochemical battery cell disposed through the perforations of FIG. 2, where the flexible laminate is folded back upon itself.

FIG. 4 is a fragmentary front elevational view of the electrochemical battery cell of FIG. 3 showing the electrochemical battery cell with heat sealed edges and electrically insulating tape placed about the periphery of the non-folded edges of the flexible laminate.

### DETAILED DESCRIPTION OF EXEMPLARY

### Embodiments of the Invention

The following description of technology is merely exemplary in nature of the subject matter, manufacture and use of one or more inventions, and is not intended to limit the scope, application, or uses of any specific invention claimed in this application or in such other applications as may be filed claiming priority to this application, or patents issuing therefrom. Regarding the methods disclosed, the order of the steps presented is exemplary in nature, and thus, the order of the steps can be different in various embodiments where possible. Except where otherwise expressly indicated, all numerical quantities in this description are to be understood as modified by the word “about” and all geometric descriptors are to be understood as modified by the word “substantially” in describing the broadest scope of the technology.

The present technology is drawn to various battery cells, including a battery cell that has an electrochemical battery cell and a flexible laminate. The electrochemical battery cell can have at least one terminal and the flexible laminate can be configured as a pouch. The pouch can define an interior and an exterior where the electrochemical battery cell can be disposed in the interior. The pouch can have a folded edge of the flexible laminate including a perforation formed in the folded edge. The terminal can be disposed through the perforation where a portion of the terminal can be exposed to the exterior of the pouch.

Various methods of making such battery cells are provided, where methods can include perforating the flexible laminate to form the perforation therein. The terminal of the electrochemical battery cell can be disposed through the perforation. The flexible laminate can be formed into the pouch, where the pouch defines an interior and an exterior. The electrochemical battery cell can be disposed in the interior and the terminal can be disposed through the perforation so that a portion of the terminal can be exposed to the exterior of the pouch.

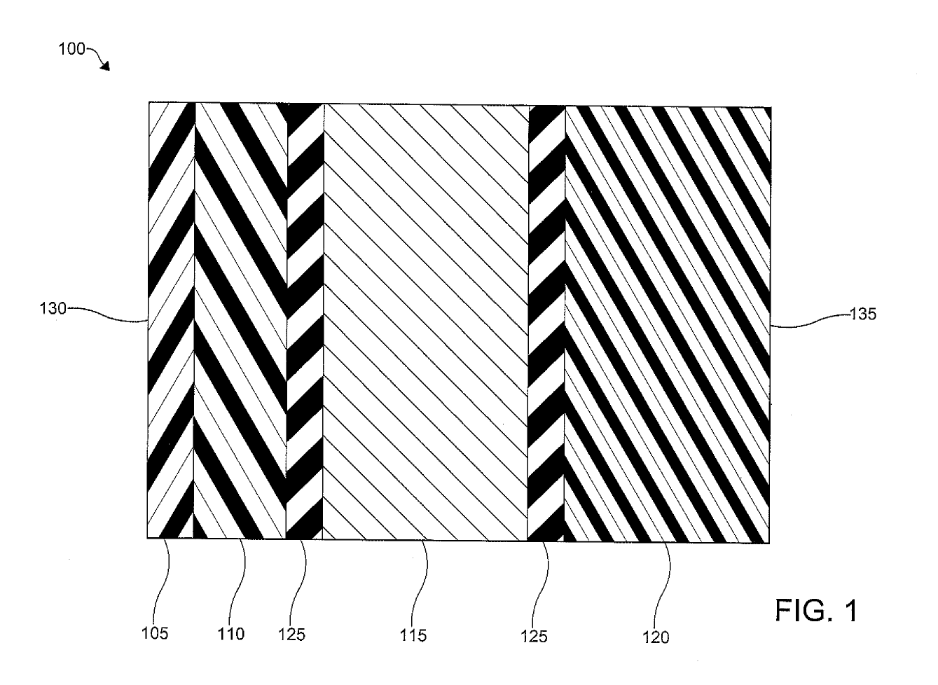

Embodiments of the present technology are further described by reference to FIGS. 1-4.

With reference to FIG. 1, a cross-section of an embodiment of a flexible laminate 100 used to form a battery cell pouch is shown. The flexible laminate 100 can include a plurality of layers of various thicknesses, including one or more barrier layers and/or one or more polymeric layers including electrically nonconductive layers. The barrier layer can include one or more various metallic layers and the polymeric layer can include one or more various thermoplastic polymers, including various polyolefins, polyamides, and polyesters. These layers can prevent various fluids from permeating and migrating through the flexible laminate, including various gases and liquids used within the electrochemical battery cell and those generated during charging/discharging cycles. Such fluids can include liquid electrolytic solutions containing organic solvents, electrolytes, additives, and gases generated therefrom. Where the barrier layer includes a metallic layer, the metallic layer can be electrically conductive.

The embodiment of the flexible laminate 100 shown in FIG. 1 has the following layers and approximate thicknesses: a polyethylene terephthalate layer 105 (12 microns), a nylon layer 110 (15 microns), an aluminum layer 115 (40 microns), and a polypropylene layer 120 (80 microns). Tie layers 125 (<5 microns) of adhesive or glue are used to bond the aluminum layer 115 to the nylon layer 110 and the polypropylene layer 120, respectively. The polyethylene terephthalate layer 105 forms an exterior surface 130 of the battery cell pouch and the polypropylene layer 120 forms an interior surface 135 of the battery cell pouch.

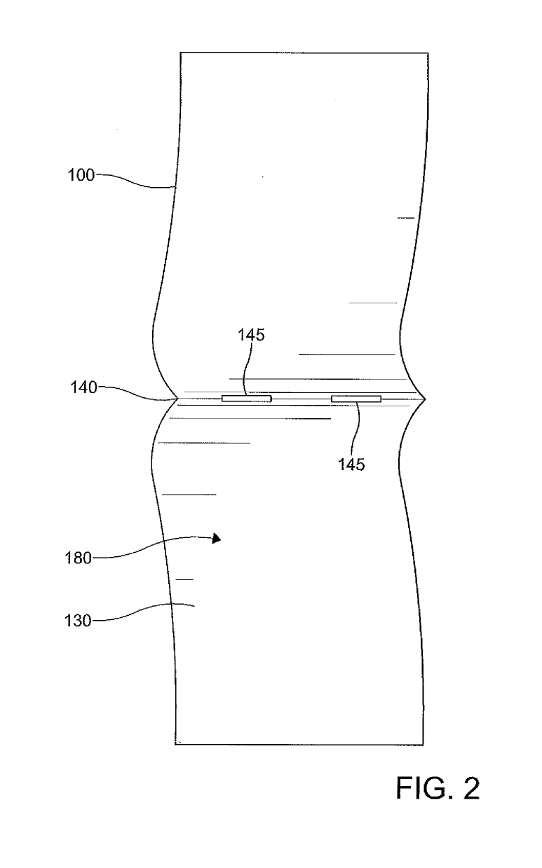

With reference to FIG. 2, a sheet of the flexible laminate 100 is shown having a fold line 140 formed therein. Two perforations 145 in the flexible laminate 140 are located at the fold line 140. The flexible laminate 100 can be folded or creased to form the fold line 140, where the fold line 140 can be used to locate where the perforations 145 are to be made. Alternatively, the perforations 145 can be made in the flexible sheet 100 and the sheet folded or creased along the location of the perforations 145. The depiction of the fold line 140 serves to mark the location of the perforations 145 and where the flexible laminate 100 is folded back upon itself in FIG. 2. However, in certain embodiments, a fold line 140 may not be formed in the flexible laminate 100, as a single folding event can be used to fold the flexible laminate 100 in making the battery cell and the folded flexible laminate 100 may never be unfolded or opened thereafter to reveal a fold line 140. Methods also include concomitantly folding the flexible laminate 100 and perforating the flexible laminate 100 to form the perforations 145. The perforations 145 in the flexible laminate 100 can be made in various ways, including cutting and/or punching holes in the flexible laminate 100, using various stamps, punches, blades, rollers, heated tools, lasers, etc. More or fewer perforations can be formed as desired. Further, the perforations can have any shape as desired.

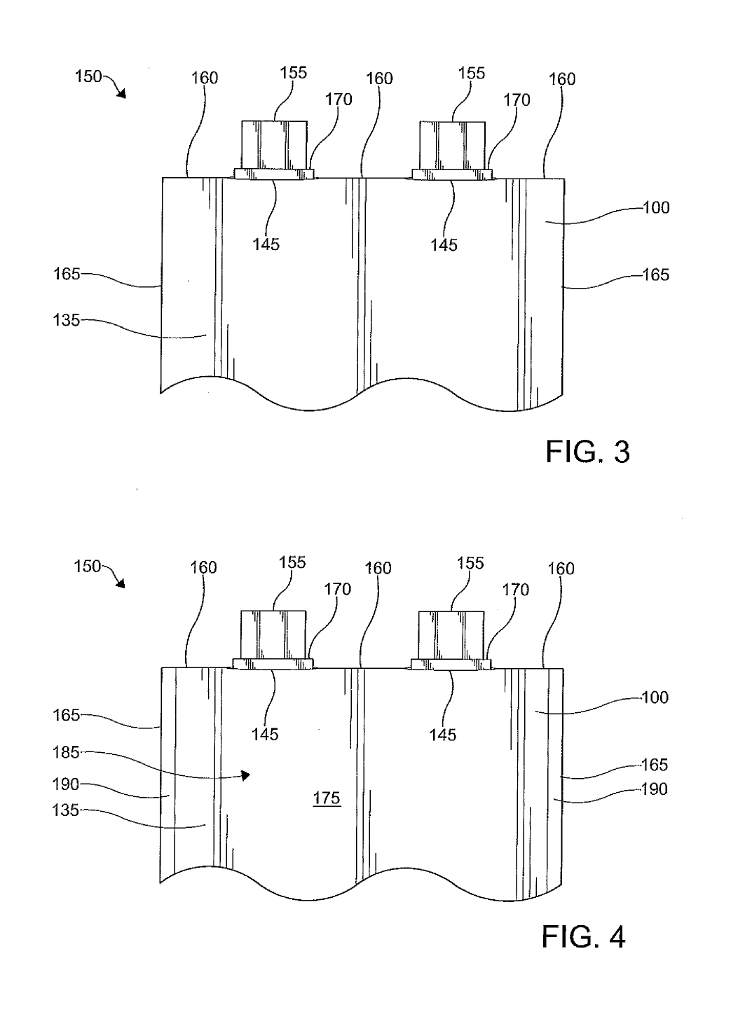

With reference to FIG. 3, a portion of a battery cell 150 is shown. A terminal 155 of an electrochemical cell (not shown) is disposed through each perforation 145. The flexible laminate 100 is folded back upon itself to provide a folded edge 160. The folded edge 160 is interrupted by each terminal 155 passing through the flexible laminate 100. Other edges 165 of the battery cell 150 are formed by bringing two edges of the flexible laminate 100 together when the flexible laminate 100 is folded. An insulator 170 can be fitted about each terminal 155 proximate to each perforation 145 to electrically insulate the terminal 155 from the flexible laminate 100. The insulator 170 can also operate as a sealant to seal any space or gap between the terminal 155 and the perforation 145 in the flexible laminate 100. For example, the insulator 170 can be configured as a collar disposed about the terminal 155. The insulator 170 can also be configured to melt or partially melt in the presence of heat, serving to help seal the battery cell 150. The entire folded edge 160, including each insulator 170, can be heat sealed.

With reference to FIG. 4, the flexible laminate 100 is formed into a pouch 175 defining an interior 180 (see portion of flexible laminate 100 in FIG. 2 that forms the interior 180) and an exterior 185. The electrochemical cell (not shown) of the battery cell 150 is placed within the interior 180 of the pouch 175 and the terminals 155 of the electrochemical cell are disposed through the perforations 145 so that a portion of each terminal 155 is exposed to the exterior 185 of the pouch 175. Joined edges 165 of the battery cell 150 that are formed by bringing two edges of the flexible laminate 100 together when the flexible laminate 100 is folded can be sealed by heat sealing and by covering with a material 190, such as an electrically insulating tape. It is not necessary to seal and cover the folded edge 160 with the material 190. In this way, for example, there is no need to apply a complex taping operation along the folded edge 160, where application of the electrically insulating tape is interrupted by the terminals 155 passing through the perforations 145 along the folded edge 160. The joined edges 165 of the battery cell 150, including the insulators 170, can also be heat sealed.

Sealing of the joined edges 165 with the material 190 (e.g., electrically insulating tape) can serve to electrically insulate any exposed electrically conductive layers at the edge of the flexible laminate 100. For example, a barrier layer of the flexible laminate 100 formed of a metallic layer can be electrically conductive and can be exposed about the periphery of the flexible laminate 100; e.g., the aluminum layer 115 shown in FIG. 1. The material 190 accordingly reduces or prevents the barrier layer from passing electrical current and minimizes reaction or corrosion of the barrier layer with various fluids used within or that contact the battery cell 150.

The present technology accordingly provides several benefits and advantages in optimizing the assembly and performance of the battery cell 150. Application of the material 190 (e.g., electrically insulating tape) about the periphery of the battery cell 150 is simplified by the use of the folded edge 160 with the terminals 155 disposed through the perforations 145, as it is not necessary to apply the material 190 along the folded edge 160. Unlike the joined edges 165, the folded edge 160 does not have an exposed barrier layer like a metallic/conductive layer (e.g., aluminum layer 115 in FIG. 1). As such, the material 190 does not need to be applied along the folded edge 160, where such an operation is complicated by having to negotiate the terminals 155 projecting therefrom and would require developing an application process for the material 190 that can accommodate interruption by the terminals 155.

Example embodiments are provided so that this disclosure will be thorough, and will fully convey the scope to those who are skilled in the art. Numerous specific details are set forth such as examples of specific components, devices, and methods, to provide a thorough understanding of embodiments of the present disclosure. It will be apparent to those skilled in the art that specific details need not be employed, that example embodiments may be embodied in many different forms, and that neither should be construed to limit the scope of the disclosure. In some example embodiments, well-known processes, well-known device structures, and well-known technologies are not described in detail. Equivalent changes, modifications and variations of some embodiments, materials, compositions and methods can be made within the scope of the present technology, with substantially similar results.

What is claimed is:

1. A battery cell comprising:
an electrochemical battery cell including a first terminal; and
a flexible laminate configured as a pouch, the pouch defining an interior and an exterior, the electrochemical battery cell disposed in the interior, the pouch including a folded edge of the flexible laminate having a first perforation therein, the first terminal disposed through the first perforation with a portion of the first terminal exposed to the exterior of the pouch.

2. The battery cell of claim 1, wherein the electrochemical battery cell includes a second terminal.

3. The battery cell of claim 2, wherein the folded edge includes a second perforation, the first terminal disposed through the first perforation with a portion of the first terminal exposed to the exterior of the pouch, and the second terminal disposed through the second perforation with a portion of the second terminal exposed to the exterior of the pouch.

4. The battery cell of claim 1, wherein the flexible laminate includes a barrier layer.

5. The battery cell of claim 4, wherein the barrier layer includes a metallic layer.

6. The battery cell of claim 5, wherein the metallic layer includes aluminum.

7. The battery cell of claim 1, wherein the flexible laminate includes an electrically conductive metallic layer disposed between a first polymeric layer and a second polymeric layer.

8. The battery cell of claim 1, wherein the pouch includes a joined edge formed by two edges of the flexible laminate.

9. The battery cell of claim 8, wherein the joined edge is covered with a material.

10. The battery cell of claim 9, wherein the material includes an electrically insulating material.

11. A battery assembly comprising:
a plurality of battery cells, each battery cell including
an electrochemical battery cell including a terminal; and
a flexible laminate configured as a pouch, the pouch defining an interior and an exterior, the electrochemical battery cell disposed in the interior, the pouch including a folded edge of the flexible laminate having a perforation therein, the terminal disposed through the perforation with a portion of the terminal exposed to the exterior of the pouch.

12. A method of making a battery cell comprising:
perforating a flexible laminate to form a perforation therein;
disposing a first terminal of an electrochemical battery cell through the first perforation; and
forming the flexible laminate into a pouch, the pouch defining an interior and an exterior, the electrochemical battery cell disposed in the interior, the first terminal disposed through the first perforation with a portion of the first terminal exposed to the exterior of the pouch.

13. The method of claim 12, further comprising the step of folding the flexible laminate to form a folded edge, the first perforation located on the folded edge.

14. The method of claim 13, wherein the perforating step is completed prior to the folding step.

15. The method of claim 13, wherein the folding step is completed prior to the perforating step.

16. The method of claim 12, wherein the electrochemical cell includes a second terminal.

17. The method of claim 16, wherein the perforating step includes perforating the flexible laminate to form a second perforation, the first terminal disposed through the first perforation with a portion of the first terminal exposed to the exterior of the pouch, and the second terminal disposed through the second perforation with a portion of the second terminal exposed to the exterior of the pouch.

18. The method of claim 12, wherein the flexible laminate includes a barrier layer.

19. The method of claim 18, wherein the pouch includes a joined edge formed by two edges of the flexible laminate.

20. The method of claim 19, further comprising the step of covering the joined edge with an electrically insulating material.
